(19) United States
(12) Patent Application Publication
(10) Pub. No.: US 2026/0177802 A1
(43) Pub. Date: Jun. 25, 2026

(54) Microscopy System and Method for Defining Microscope Settings

(71) Applicant: Carl Zeiss Microscopy GmbH, Jena (DE)

(72) Inventors: Manuel Amthor, Jena (DE); Daniel Haase, Zoellnitz (DE)

(21) Appl. No.: 19/365,330

(22) Filed: Oct. 22, 2025

(30) Foreign Application Priority Data
Dec. 20, 2024 (DE) 10 2024 139 249.5

(51) Int. Cl. G02B 21/24; G16Y 40/35

(52) U.S. Cl. CPC G02B 21/244; G16Y 40/35

(57) ABSTRACT

In order to define microscope settings for a planned microscope experiment, an embedding vector is calculated from a textual experiment description by means of an embedding model. Microscope settings are derived from the embedding vector using a database that contains stored embeddings for experiment descriptions with respectively associated predetermined microscope settings. The derived microscope settings can be used to capture at least one microscope image.

### REFERENCE TO RELATED APPLICATIONS

The current application claims the benefit of German Patent Application No. 10 2024 139 249.5, filed on 20 Dec. 2024, which is hereby incorporated by reference.

### TECHNICAL FIELD

The present disclosure relates to a microscopy system and a computer-implemented method for defining microscope settings for a planned microscope experiment.

### BACKGROUND OF THE DISCLOSURE

Many modern microscopes are highly complex measurement systems, the operation of which requires a high level of expertise and experience. The setting of suitable imaging parameters in an optimal manner is consequently often very time-consuming, even for experienced users. Microscope settings that have been set in a sub-optimal manner can result in various drawbacks, in particular a diminished image quality, an unnecessary subjection of biological samples to stress, or an increase in the amount of time that is required to conduct an experiment.

So-called wizards are used to simplify the operation of a microscope and to determine suitable microscope settings. A wizard consists in software that asks the user for relevant properties of an experiment to be conducted, whereupon the user can, for example, select an answer from a drop-down menu. The wizard then sets the microscope settings as a function of the answers provided. These relatively simple wizards simplify operation but cannot implement complex requirements. Wizards are also typically unable to respond to measurement results or ask individual follow-up questions in response to user input. A set process is followed, wherein all paths are executed statically, even when they are not really suitable for certain experiments. Wizards can only be enhanced to cover new types of experiments with considerable effort.

The use of automatic workflows for a microscope experiment with machine-learned models is described, for example, in U.S. Pat. No. 12,002,273 B2. To adapt workflows, data from a conducted microscope experiment is sent to a cloud computing device, which carries out a new training of the machine-learned model with this data. The newly trained model is then better suited to the type of experiment in question. Although this makes an adaptation of the workflow possible, the effort involved in a new training of the model can be substantial.

In principle, in order to set suitable microscope settings automatically or to find suitable microscope settings for new experiments, parameters can be set by reinforcement learning. This kind of approach is difficult to implement, however, because the imaging parameter space is very large. It would also be necessary to capture at least one image after each modification of the parameter settings in order to evaluate whether the modification has resulted in an improvement or a deterioration to allow a continued optimization and iterative improvement of the settings. Such an approach is thus disadvantageous in terms of the time and computational effort involved.

For a better understanding of the technical background of the invention, reference is made to different machine learning techniques in the following.

For an effective processing of text data, in particular transformer-based language models (large language models, LLMs) like GPT and BERT are used, as described, for example, in:
Brown, T., et al., “Language Models are Few-Shot Learners”, arXiv: 2005.14165v4 [cs. CL] 22 Jul. 2020
Devlin, J., et al., “BERT: Pre-training of Deep Bidirectional Transformers for Language Understanding”, arXiv:1810.04805v2 [cs. CL] 24 May 2019

The transformer technology described in these articles can also be applied to image processing. A model known as VisionTransformer ViT, which uses a transformer for image processing, is described in:
Dosovitskiy, A., et al., “AN IMAGE IS WORTH 16×16 WORDS: TRANSFORMERS FOR IMAGE RECOGNITION AT SCALE”, arXiv: 2010.11929v2 [cs.CV] 3 Jun. 2021

Alternatively to ViTs, convolutional neural networks (CNNs) are also widely used for image processing. One approach to using a CNN—which has been trained in a supervised manner for a specific task—for another task is described in:
Donahue J., et al., “DeCAF: A Deep Convolutional Activation Feature for Generic Visual Recognition”, Proceedings of the 31st International Conference on Machine Learning, PMLR 32(1):647-655, 2014.

A model known as CLIP learns a mapping of language and associated image data into a common multimodal feature space, to which end the output of an image encoder (e.g., ResNet or ViT) and the output of a text encoder are respectively projected into the common feature space, for example by a linear mapping, as described in:
Radford, Al., et al., “Learning Transferable Visual Models From Natural Language Supervision”, arXiv:2103.00020v1[cs. CV] 26 Feb. 2021

Transformer-based models predominate in the processing of text data. Alternatively, an efficient processing of sequential data is also possible using recurrent neural networks (RNNs), for example xLSTMs, as described in:

### Beck, M., et al., “xLSTM: Extended Long Short-Term Memory”, arXiv:2405.04517v1 [cs.LG] 7 May 2024

High-dimensional data can be represented in a low-dimensional space by means of machine-learned encoders. Alternatively or additionally, high-dimensional data can be mapped to a low-dimensional embedding space by means of a t-distributed stochastic neighbor embedding (t-SNE), wherein a distance between the embedded data in this space is a function of the similarity of said data, see also:
van der Maaten, L., et al., “Visualising Data using t-SNE”, Journal of Machine Learning Research 9 (2008 ) 2579-2605, Nov. 2008

### SUMMARY OF THE DISCLOSURE

It can be considered an object of the invention to specify a microscopy system and a computer-implemented method by means of which suitable microscope settings for a planned microscope experiment can be determined largely automatically and it is relatively easy to adapt the procedure to new types of experiments.

This object is achieved by the microscopy system and the method with the features of the independent claims.

A computer-implemented method according to the invention for defining microscope settings for a planned microscope experiment involves at least the following: receiving an experiment description that includes at least one textual description pertaining to a planned sample analysis; calculating an embedding vector based on the experiment description by means of an embedding model that calculates an embedding in a feature space (embedding space) from an input; deriving microscope settings from the embedding vector using a database that contains stored embeddings for experiment descriptions with respectively associated predetermined microscope settings; and using the derived microscope settings to capture at least one microscope image.

A microscopy system of an embodiment according to the invention includes a microscope for image capture and a computing device that is configured to execute a computer-implemented method according to the invention.

The invention also includes a non-volatile computer-readable data memory that includes a computer program with commands which, when executed by a computer, cause the computer to execute at least one computer-implemented method according to the invention.

The invention allows suitable imaging parameters for a microscope to be derived automatically from a textual experiment description so as to achieve a high image quality with a much simpler operation. At the same time, the time required to perform this operation is advantageously reduced.

The described use of the database offers advantages over an approach that involves mapping a textual experiment description directly to the microscope settings by means of a machine-learned model. In particular, new experiment descriptions with associated microscope settings can be readily added to the database without retraining a machine-learned model. This stands in marked contrast to, for example, the approach described in U.S. Pat. No. 12,002,273 B2 of retraining a machine-learned model in order to adapt said model to a new type of experiment.

In addition, in contrast to machine-learned end-to-end models, the database allows a direct data anonymization. This makes it easier to use user data to expand the database and thereby improve the automatic definition of microscope settings for planned microscope experiments. The textual experiment descriptions themselves (and optional associated captured images) are not stored in the database, but rather only abstract numerical representations of the same, namely the embeddings, together with associated microscope settings. In order to improve a machine-learned end-to-end model so as to take into account settings of new experiments, on the other hand, the training data would have to be supplemented with new textual experiment descriptions, which in many cases would not be permitted due to a lack of data anonymization.

### Further Optional Designs

Variants of the invention are the object of the dependent claims and are explained in the following description.

### Experiment Description/Experiment-specific Contextual Information

An experiment description can contain, for example, textual information regarding the employed sample, properties of an image to be captured and/or information regarding successive processes.

Textual experiment descriptions can stem in particular from a user and can be written in natural or technical language. For example, a macro of an earlier imaging or a log file that relates to the interaction between the user and the microscopy system can be written in technical language.

It is also possible for experiment descriptions to have been at least partially spoken and subsequently converted into text form using speech recognition software.

It is optionally also possible to input further experiment-specific contextual information into the embedding model together with a textual experiment description. The experiment-specific contextual information can be multimodal, i.e. it can also include non-textual data in addition to textual data. For example, the experiment-specific contextual information input into the multimodal embedding model can include at least text data and image data, optionally also video data and/or acoustic data. As described by the Applicant in US20220382035A1, acoustic data can, for example, have been captured by at least one microphone on the microscope and can provide information regarding a type of sample carrier a user is positioning on the microscope (by distinguishing between the sounds that are made during the placing of different glass slides, microtiter plates, etc.). It is also possible to detect specific workflow noises, ambient noises or sample noises that provide information on an employed sample, an employed sample carrier, employed microscope components or planned sample analyses.

Image data can in particular include a macroscopic overview image of an employed sample carrier and/or sample. Any markings on the sample carrier can be detected and read in the overview image, for example barcodes or label areas on which, for example, the dyes present in the sample can be indicated. Alternatively or additionally, image data can also include a microscopic image of the sample or reference data of a previous image capture. It is also possible for image metadata to form part of the experiment-specific contextual information for the input into the embedding model. Metadata can relate, for example, to the microscope components or microscope settings employed for the capture of an associated image.

Video data can include successively captured sample images or overview images of a sample carrier. Alternatively or additionally, video data can also include video documentation of a previous imaging, wherein the video shows, for example, the content of a computer screen display, for example software for controlling the microscope and software settings entered by a user.

Receiving the experiment description can include an inputting of the experiment description or parts of the same by a user, for example by speaking or in text form using a computer. Receiving the experiment description or parts of the experiment description can also include a loading of one or more files in response to a command of the user (for example a voice command: “Use settings to capture an image as shown in FIG. 2 of Paper XY”) and using the content of said file(s) for the experiment description. Receiving parts of the experiment description can also include automatically performing a measurement, for example capturing an overview image, and using measurement data or information obtained from the same - for example text in the overview image determined by OCR - as part of the experiment description. Furthermore, receiving parts of the experiment description can include an automatic querying and use of system information of the microscopy system, for example information regarding provided microscope components or log data.

### Embedding Model

The embedding model calculates an embedding vector based on at least the (textual) experiment description, wherein the embedding vector represents a numerical description of the experiment. The input into the embedding model thus includes a (multimodal) experiment description that contains experiment-specific contextual information for a planned microscope experiment for which microscope settings are sought.

One aim of the embedding model is to map an experiment description to a numerical vector (embedding vector) in a corresponding feature space (embedding space) in such a manner that similar microscope experiments are at a small distance from one another in the embedding space, while dissimilar experiments are at a large distance from one another in the embedding space. There thus occurs a semantic embedding into a semantic feature space.

For a better linguistic differentiation, the mapping of a known/given experiment description by the embedding model into the feature space is called an “embedding” here, while the mapping of the experiment description (for which suitable microscope settings are sought) by the embedding model into the feature space is called an “embedding vector”. Embeddings and the embedding vector thus both respectively represent a vector or point in the feature space.

The feature space to which new embedding vectors are added is fixed or invariable. In other words, if a new embedding vector is calculated based on new experiment descriptions, the values of existing embeddings for other experiment descriptions remain the same. In general, the feature space is understood as a space that is spanned by the possible outputs of the embedding model. The feature space is semantic, i.e. points (embedding vectors/embeddings) that are close to each other in the feature space describe similar microscope experiments. Whether different experiments are described in a similar manner or not should be of no consequence. To this end, the experiment description can be input into a machine-learned language model (large language model, LLM), which calculates a standardized experiment description from the experiment description. Only after this standardization is the experiment description input into the embedding model. The standardized experiment description can in particular be standardized or rendered uniform linguistically (for example with regard to a language and a writing style) and with regard to a data format. This ensures that a proximity of the embeddings of two experiment descriptions in the feature space is not a result of, for example, a similar writing style used to describe what are in fact quite different experiments.

The embedding model can be or can include a machine-learned model, in particular a deep neural network. The contents of the database, on the other hand, are stored in the form of tabular values and not as model parameter values of a machine-learned model.

A multimodal embedding model can include different input strings for, for example, textual data, image data and video data. The input data can be mapped together to an embedding vector or, alternatively, the input data of different input strings can be respectively mapped to a vector in the same feature space and these vectors are subsequently combined into an embedding vector, for example by averaging.

The embedding model can be a machine-learned encoder, for example an autoencoder. An autoencoder includes an encoder followed by a decoder. The encoder calculates a representation in a lower dimension (in an embedded space) from an input, while the decoder projects this embedded representation back into the original space. The output of the autoencoder should match the input. Input data that corresponds in type to the inputs to be used in the inference phase can be used to train the autoencoder. In the context of the present invention, the inputs are thus experiment descriptions, which can optionally be pre-processed, for example by a LLM, so that they are formally uniform. Autoencoders are suitable for any modality (text, images, etc.) and can include, for example, convolutional neural networks (CNNs) and/or transformer-based networks.

The embedding model can also be designed as an encoder, provided that an autoencoder was not used in the training to learn the encoder parameter values. In the case of an encoder with a CNN, it is possible, for example, to run at least one image through the network, wherein a plurality of convolutional layers extract features. The outputs (“feature maps”) of the CNN from an intermediate layer, in particular before the fully connected layers of a CNN structure, can be used as an embedding vector for the image. It is possible to use, for example, a CNN similar to the one described in the article by Donahue et al. cited in the introduction, wherein the output of an intermediate layer, referred to in this article as DeCAF6 features or DeCAF7 features, is used as the embedding vector. It is in principle also possible for such a structure to be used for audio data, time series (with 1D CNNs) or text instead of an image.

The embedding model can also process transformer-based image data and be designed, for example, as a VisionTransformer (ViT). ViTs divide an image into individual patches, project these patches into an embedded space, and then process them with a transformer encoder. An output of the transformer encoder or a vector calculated from the outputs of the transformer encoder can be used as an embedding vector. For example, the resulting sequence of individual embeddings can be used for the final embedding of the complete image (for example by averaging or concatenation). It is alternatively possible to use the end embedding vector of a special [CLS] token. A [CLS] token is added to the sequence of patches in this case; the processing via a plurality of attention blocks provides the embedding of the [CLS] token with information from each processed image patch, so that the embedding of the [CLS] token can be deemed to be representative of the entire image and used accordingly. In addition to image data, ViTs are also suitable for input data in the form of videos.

The embedding model can also process transformer-based text data and can be or can include at least one large language model (LLM). The language model can, for example, have the structure of a generative pre-trained transformer (GPT) or an encoder transformer like BERT. Processing is analogous to the processing described for ViT, wherein textual data is divided into tokens instead of image patches. A multimodal large language model can additionally include a ViT or other transformer-based encoder for image patches in order to process both text data and image data, or optionally also acoustic data or video data.

Alternatively, the embedding model can also be formed by recurrent neural networks (RNNs) or can include at least one such network, for example an (x)LSTM, which can be formed as described in the introduction of the present description. An xLSTM is in particular feasible when the input takes the form of text, audio data and/or time series.

Hybrid forms of the aforementioned models are also possible. For example, an overview image of a sample carrier can be captured. The image itself is embedded by a CNN. At the same time, the label area on the sample carrier in the image is segmented. The text it contains is then recognized by optical character recognition (OCR) and embedded by an LLM.

Alternatively, the embedding model can also be implemented based on “classic” machine learning, for example using a bag-of-visual-words (BoW) method for images and/or a latent Dirichlet allocation (LDA) for text data. Generally speaking, however, deep learning methods make it easier to achieve high-quality results.

Training data for the embedding model can include experiment descriptions as used in the inference phase as input. Alternatively, it is also possible to use other input data in the training, since in principle an embedding into a semantic feature space can also be learned from other input data. The training can in particular be supervised or self-supervised. A training objective can correspond to the objective in the inference phase, to which end, for example, at least one output layer is added at the end of the embedding model in the training, experiment descriptions are used as inputs, and predetermined microscope settings are used as annotations. Alternatively, a training objective can also be independent of the use of the embedding model in the inference phase, as is the case in the article by Donahue cited in the introduction. Annotations in the training can take the form of, for example, relevant experiment data that the model is to extract from an input experiment description, for example a specification of the sample type, the contrast type, employed dyes, a performed sample preparation, a desired image content (e.g., cell type and cell stage) and a necessary magnification or objective selection based on the desired image content, and whether a bleaching of the sample is permitted.

### Single-step or Multi-step Embedding Model; Joint or Individual Embedding

The embedding model can map an input to the feature space in one or more steps. In a single-step implementation, a mapping into the (final) feature space is calculated directly from the input. This can also be done for different modalities in a similar manner to what is described in the article on the model known as CLIP cited in the introduction. For instance, a textual experiment description and associated image data can first be processed by a respective encoder, whereupon the encoder outputs are projected into a shared multimodal feature space, e.g. by linear mapping. In a multi-step implementation, an input is first mapped to at least one or more individual intermediate spaces, from which it is then mapped to the final embedding space.

All components of an experiment description, which can include textual information and optional additional information, can be embedded together as a unit. The input into the embedding model represents the set of all experiment-specific contextual information, and the output of the embedding model is an embedding vector in the feature space.

Alternatively, components of an experiment description can be embedded into the feature space individually. For each piece of contextual information (or for each group of contextual information), the embedding model calculates a vector in the embedding space. A piece of contextual information or a group of contextual information can be, for example: an image; details of the microscope system configuration; details of the employed sample; a specification of the employed sample carrier. This results in a plurality of vectors/points in the embedding space for the collective unit of experiment-specific contextual information. The embedding vector (and optionally further information) is calculated from these points in the embedding space. For example, the vectors/points can be averaged (weighted) or combined into a single vector (embedding vector) by finding a centroid or in some other manner. The points can also be combined into an extended representation, for example into a mean vector, which represents the embedding vector, and a variance vector, which describes the variance of the individual vectors around the mean vector. Alternatively, the individual vectors/points can be retained as a set, so that a set of vectors is then applied instead of a single vector. The set of individual vectors can be regarded as the embedding vector in this case.

### Database of Known Microscope Experiments

The database of known microscope experiments can consist of, i.e. contain, embeddings (embedding vectors) and associated optimal microscope settings.

The embeddings were extracted from experiment descriptions and thus do not include the experiment descriptions themselves, but only their embedding. This achieves a certain degree of anonymization, as the embedding only comprises a numerical vector which, although it contains all the information that is relevant for setting the parameters, does not include any sensitive details (for example, images of a sample, exact textual experiment description, etc.).

Data in the database are not model parameter values (of the embedding model or any other learned model) but can be tabular values. A table can contain a plurality of embeddings (respectively calculated from an experiment description) and an associated set of microscope settings for each embedding.

As described in more detail later on, new entries can be readily added to the database without necessitating a retraining or follow-up training of the embedding model or any other machine-learned model.

### Deriving microscope settings using an embedding vector and a database

Known imaging parameters or microscope settings from previous experiments can be used to derive imaging parameters for a new experiment. For an embedding vector (which encodes the experiment description for a new experiment), embeddings of similar microscope experiments are determined in the embedding space based on the distance of these experiments from the embedding vector in the embedding space. Known or suitable microscope settings are stored in the database for each microscope experiment. Microscope settings for the new experiment are defined based on the microscope settings stored in the database for one or more of the most similar microscope experiments that are found.

Optionally, the derivation of microscope settings from the embedding vector using the database can at least include a determination of which stored embedding in the database is closest to the embedding vector of the input in the feature space in terms of distance. The microscope settings are then defined at least based on the microscope settings of the closest stored embedding. For example, the microscope settings of the closest stored embedding can be used as microscope settings for the new experiment.

Different distance measures can be used to determine a distance in the feature space such as, for example, the L1 distance (Manhattan distance) or L2 distance (Euclidean distance). More complex distance measures are also possible. For example, it is possible to determine for which embeddings or regions in the feature space there is a uniform value of a given discrete microscope setting (e.g. contrast method), whereupon regional boundaries are defined in the feature space (for example so that different defined regions in the feature space represent different contrast methods). Crossing a regional boundary registers as a penalty point or an increase in distance. A given Euclidean distance between two points in the feature space thus varies in magnitude depending on whether the two points are in the same region or in different regions of the feature space.

It is also possible to select a plurality of stored embeddings for the derivation of microscope settings. The selection is made according to the proximity of the embeddings to the embedding vector in the feature space, i.e. the selection includes the closest embedding, the second closest embedding, etc. The selection can be made similarly to k-nearest neighbor methods. The definition of the microscope settings now occurs based on the microscope settings of the selected plurality of stored embeddings. Optionally, a number of stored embeddings to be selected can be predetermined so that, for example, the three closest embeddings are always used. Alternatively, it is possible to select every stored embedding within a predefined radius around the embedding vector, whereby the number of embeddings used is variable. In a further variant, a further embedding is selected until a ratio of a distance between a last selected embedding and a further embedding exceeds a predetermined threshold value. This essentially selects all embeddings from a same cluster, while embeddings that are further away from this group of embeddings are not used.

The derivation of microscope settings from the embedding vector using the database can alternatively or additionally include at least the following: The embeddings in the feature space are clustered and a cluster associated with the embedding vector is determined. Clustering can be understood as assigning points that lie close to one another in the feature space to a same group (cluster). This divides the feature space into different clusters. The embeddings from the cluster in which the embedding vector is located are selected. Microscope settings are then derived from the microscope settings of the selected embeddings, i.e. the embeddings of the cluster associated with the embedding vector. It is also possible to use another embedding method, for example a (t-distributed) stochastic neighbor embedding (t-SNE), to cluster points in the feature space.

In one variant, it is possible for all existing embeddings of known experiments in the embedding space to be clustered, for example by t-SNE, and to subsequently receive a cluster ID. Depending on its position in the feature space or its proximity to embeddings of known experiments, an embedding vector is then assigned all embeddings with a given cluster ID. Thus, instead of selecting a single embedding, all embeddings of a cluster are selected in order to derive microscope settings.

For microscope settings with continuous value ranges, the microscope settings of a plurality of selected embeddings can be interpolated or combined with one another, for example by a weighted averaging. The weighting occurs as a function of the distance in the feature space between the embedding vector and a respective embedding, so that the weighting becomes weaker with increasing distance. It is possible for it to be stored in the database for different microscope settings whether they have a continuous value range, i.e. whether they can be averaged or interpolated. A microscope setting that cannot be interpolated is, for example, the employed contrast type (fluorescence, phase contrast, DIC, etc.). On the other hand, microscope settings with continuous value ranges are, for example, a measurement or illumination duration, limits of an area of analysis, a z-focus or z-step sizes for the focus determination.

### Approval and/or Refinement of Derived Microscope Settings

The microscope settings derived using microscope settings stored in the database for similar experiments can either be used for measurements immediately or only after an approval and/or a refinement of the values of the microscope settings.

In particular, a user and/or a control software can be asked to A) approve the derived microscope settings in order to capture at least one microscope image with the same, and/or B) refine the derived microscope settings in order to obtain refined microscope settings for the planned microscope experiment. Optionally, the request for approval is made first and a refinement is carried out only in the event that approval is not given by a user or control software.

A control software can include, for example, one or more machine-learned models that check the derived microscope settings with regard to plausibility and/or whether predetermined boundary conditions are met. Boundary conditions can relate, for example, to the presence of selected microscope components or to ensuring that a planned sample stage movement does not result in a collision with system components (objective, immersion unit, etc.).

Optionally, there can occur an automatic fine-tuning of the derived microscope settings, to which end a plurality of test images are captured/test measurements are performed with differently varied microscope settings. The derived microscope settings are varied in different ways for this purpose; for example, parameters with a continuous value range can be varied within a predetermined interval, for example 5% of the derived value. The variation can be random or can take, for example, compatibility criteria into account in order to retain a compatibility with other microscope settings. The test images are then evaluated. The automatic evaluation can be based, for example, on an image quality, an avoidance of artefacts and/or a visibility of certain objects or structures. The evaluation criteria can be defined as a function of the experiment description. For example, an object detection or object segmentation can be carried out, wherein an object type that is to be imaged according to the experiment description is sought. The microscope settings for the image with the best evaluation out of the plurality of test images are then used for the planned microscope experiment.

Alternatively or additionally, a fine-tuning of the derived microscope settings can also occur by means of an adaptive algorithm. The adaptive algorithm can be learned through machine learning using results for test images with differently varied microscope settings. Adaptive algorithms can be implemented by means of classic or machine learning algorithms and can continuously learn from results of the test images and automatically optimize the parameters. In particular, reinforcement learning (RL) methods can be used for adaptive algorithms.

### Continuous Expansion of the Database

Expanding the database with further embedding vectors is key to continuously improving the accuracy and reliability of the system. To this end, after completion of a new experiment and confirmation of the optimal microscope settings, the latter can be entered in the database together with the associated embedding vectors so that they can be used in the derivation of microscope settings for future experiments.

It is important to note that a follow-up training of a machine-learned model is not required following the expansion of the database. The database can thus be expanded readily and continuously. In contrast, a new training of a model would involve a considerable amount of additional effort, in particular in light of the large number of parameters in modern models and the necessary control procedures for validating newly trained/retrained models. The database, on the other hand, can be continuously expanded, for example after each successfully completed experiment, with a new data point. A data point is understood here to be an embedding (embedding vector) and the associated microscope settings.

It is optionally possible to choose whether the database is to be expanded locally or globally. A local expansion can be limited to one microscope or to the microscopes of one institution (for example of a company), while in a global expansion a database is expanded that can be used for in principle any number of further microscopes.

A high level of data protection is achieved, as the experiment descriptions themselves are not entered into the database, but only the abstract numerical embeddings and the corresponding imaging parameters.

In addition, experiment descriptions can be anonymized prior to their input into the embedding model so as to further increase a confidence that no sensitive or personal data is stored in the database. Anonymization can be carried out, for example, by means of an LLM, which is instructed to remove personal data from the experiment description. This operation can be carried out together with a standardization by means of the LLM. Only afterwards is the embedding model used.

Anonymization allows embedding vectors with associated microscope settings to be collected from different users or institutions and transferred to a central location, for example to a cloud or server. An updated, global database of microscopes can then be rolled out to all users. Alternatively, it is also possible to choose to expand the database only locally for a user or for an institution, but not for microscopes outside the institution.

Optionally, users can provide feedback on the derived microscope settings, which is used to further refine and expand the database.

In one embodiment, the database is expanded by the embedding vector of the experiment description and the associated derived microscope settings, provided that the derived microscope settings have been approved (by the user and/or a control software). This increases the probability that only data points that are estimated to be correct are added to the database.

Provided that a fine-tuning or a refining of the derived microscope settings as described in the foregoing has been carried out, it can be provided that the database is expanded by the embedding vector of the experiment description and the associated refined microscope settings. It is optionally also possible for it to be provided that the database is expanded in the event of a refinement, but not when derived microscope settings were used without a refinement.

It is optionally defined as a prerequisite for the expansion of the database by the embedding vector of the experiment description and the associated derived microscope settings that at least one microscope image was captured with the microscope settings and that there occurred neither an aborting of a measurement nor a discarding of the at least one microscope image by a user or a control software. Settings with which images deemed to be of unsuitable quality were captured are not entered into the database.

All variants involving an expansion of the database can optionally be supplemented by a quality control. In this case, prior to a definitive entry into the database, the new data points are checked for quality and consistency to ensure that only valid and useful information is added to the database.

### Expanding the Database by Means of a Data Augmentation

A data augmentation is conventionally used in particular in supervised learning methods to generate, from an input/annotation pair, variations of the input for which the same annotation can be used as the target in the supervised training. A variation of this approach can be utilized to expand the database for a closer coverage of the embedding space.

Thus, in cases where the database is expanded by an embedding vector with associated microscope settings, the following can be provided for a data augmentation:

An anonymization, standardization and creation of a plurality of variations of the experiment description (for which the embedding vector is added to the database) are carried out. In principle, the anonymization, standardization and variation of the experiment description can be carried out in any order. The computational effort is generally lower when an anonymization and standardization is carried out once and the anonymized, standardized experiment description is then varied a number of times in different ways. These steps can be carried out by an LLM.

Embeddings of the variations of the experiment description are then calculated by means of the embedding model. The embeddings of the variations of the experiment description are now added to the database, wherein for each of these embeddings the microscope settings that belong to the embedding vector from which the embeddings were generated by varying the experiment description are also stored. This produces a plurality of slightly different/varied embeddings for which the same microscope settings are stored in the database.

It can in particular be provided that the variation of the experiment description and the calculation of associated embeddings takes place at the location of the microscopy system and that only the embeddings of the varied experiment descriptions with associated microscope settings (but not the varied experiment descriptions themselves) are then forwarded to a central computing system or to a cloud, where the database is expanded, and the expanded database is then rolled out to different microscopy systems. A data augmentation and expansion of the database can thus occur without it being necessary to share varied experiment descriptions, which is advantageous in terms of data protection.

In principle, it is also possible for the augmentation steps to be carried out locally, independently of the experiment from which the embedding vector to be augmented originated. In this case, an anonymization of the experiment description can optionally be carried out first at the microscope system used to conduct the experiment, and the data of the anonymized experiment description is then transmitted to a computer system at which the actual augmentation occurs. Optionally, the described anonymization can also be omitted in the data augmentation.

### Providing Different Sets of Microscope Settings to Choose From

Optionally, it is not just a single set of microscope settings that is derived from the embedding vector using the database, but a plurality of sets of microscope settings. The different sets of microscope settings can differ in at least one microscope setting with discrete (non-continuous) value options, in particular in a contrast type or an employed objective. As described in the foregoing, the selection or derivation of a set of microscope settings is based on the distance between the embedding vector of the new experiment description and the embeddings stored in the database. The plurality of sets can be selected by selecting the closest embeddings in the feature space. The microscope settings stored in the database are used as a set of microscope settings for each embedding. Optionally, the closest embeddings in the feature space are selected whose microscope settings differ in at least one predetermined microscope setting, in particular in a discrete microscope setting such as the contrast type or the employed objective. The user or a control software can thus be offered a number, for example between two and ten, of qualitatively different measurement methods. The set of microscope settings selected by the user or the software can then be used for the experiment or first for the capture of a microscope image to be evaluated, optionally after an additional refinement as described above. Also optionally, it can be provided to expand the database with the microscope settings of the set of microscope settings selected by the user/software and the associated embedding vector.

### Deriving a Focus Strategy Using the Database

The data/microscope settings stored in the database for an embedding can also define parameters for a focus strategy. The derivation of microscope settings from the embedding vector using the database can thus include a derivation of a focus strategy. The derived focus strategy can then be used to conduct the planned microscope experiment.

A focus strategy, also referred to synonymously as the autofocus strategy, is divided into a coarse-focus strategy and a fine-focus strategy. This two-stage approach is important in order to cover a focus search range that is as large as possible and still find and maintain the focus during the experiment in an acceptable runtime while subjecting the sample to minimal stress.

The focus strategy optionally not only defines how a one-off focus setting is determined. Rather, the focus strategy can also define how a focus control is continuously performed throughout an experiment. If a refocusing is necessary, the focus strategy also defines how this is carried out, for example by repeating the fine focusing or by varying the previous fine-focus strategy. The focus strategy can also specify how to proceed after unsuccessful focusing attempts, as described in more detail later on.

Parameters of the coarse-focus strategy and of the fine-focus strategy can include all necessary information pertaining to both the coarse-focus strategy and the fine-focus strategy so that these strategies can be carried out in a manner that is both automated and tailored to an experiment. The parameters include microscope settings to find a coarse focus and subsequently refine the coarse focus via a further measurement. The parameters can also define actions in the event of errors, for example when a focusing is not possible: first reduce the analyzed z-distances and, should a focusing still not be possible, change the employed focus method. The parameters also include information that does not correspond to microscope settings per se, for example defined time intervals or points in a workflow for a checking and, where necessary, correction of a current focus.

Parameters of the coarse-focus strategy and fine-focus strategy can in particular respectively include a specification of a focus method to be employed, wherein a selection is made from at least two of the following methods:
a hardware autofocus method, also called as an active autofocus method, in which a suitable focus is determined by measuring a reflection of light off a sample carrier surface. A separate light source can be especially provided for this autofocus method, which emits, for example, in the far infrared and is not used for sample analysis.
a software autofocus method, also called a passive autofocus method or image contrast method, in which microscope images are captured at different height planes and a focus is derived from the microscope images. The microscope images can show the sample or in principle another structure on the sample carrier next to the sample. These images can constitute a Z-stack of the same lateral area and differ at least or solely in the focused height plane.
an AIM autofocus method (AIM: Angular Illumination Microscopy), in which a focusing is derived from differences between microscope images respectively captured with a different angular illumination. For the different illuminations, it is possible to use, for example, two LEDs, which are switched on successively and are located on opposite sides of an optical axis, so that the images that can be captured with the different illuminations are offset relative to each other.
a sample-carrier-edge/cover-glass-edge autofocus method, in which an edge or corner of a cover glass or sample carrier is detected in an overview image and a focus determination is subsequently carried out using the edge or corner. Alternatively, another sample boundary or edges of a text field can be used for this focus method.
a macroscopic height estimation based on at least one overview image. The overview image is evaluated in order to estimate the height at which a sample to be analyzed is located. Optionally, a sample carrier type can be identified in the overview image, wherein a respective height or bottom thickness is stored for different sample carrier types.

Parameters of the coarse-focus strategy and the fine-focus strategy can also specify an order in which two different focus methods are to be used. For example, the parameters can define that a hardware autofocus method is to be performed first, followed by a software autofocus method, or vice versa. This choice essentially depends on the experiment to be conducted and thus on the extracted experiment-specific information.

Parameters of the coarse-focus strategy and the fine-focus strategy can include all free parameters of a selected focus method. Free parameters are understood to mean that the values of these parameters must be defined individually, as which values deliver the best results depends on the experiment to be conducted.

In the case of a hardware autofocus method, the free parameters can include all or at least two or more of the following: offset, focus search range, illumination intensity (for example intensity of an LED used only for the focusing method), detector sensitivity and/or selection of one from among a plurality of z-determination algorithms. For example, different algorithms can be provided when a sample carrier type has three bottom parts/bottom surfaces or a filter insert is used in multiwells and dishes. An offset can indicate a z-difference between the z-focus of the autofocus illumination and the z-focus of the sample observation through the objective; when the offset is adjusted, i.e. when the z-focus of the autofocus illumination is adjusted, a height of the sample stage can be adjusted to the same extent so that the observed height plane is shifted by the offset. By means of this offset, the LED illumination can be focused on a boundary surface of the sample carrier or cover glass while a sharp image of another plane can be captured at the sample.

In the case of a software autofocus method, the free parameters can include at least: a position, number and spacing of z-planes to be captured, a sampling rate, an optimization criterion for an image quality (for example, sharpness, contrast, image variance or image energy) or a focus evaluation algorithm as mentioned in the introduction and/or a reference channel to be used, in particular a detection channel of the microscope. Optionally, the free parameters can also define an image pre-processing, for example properties of a noise reduction, smoothing, image sharpening or deconvolution.

Additionally or alternatively, parameters of the coarse-focus strategy and parameters of the fine-focus strategy can respectively specify a number and a lateral position of autofocus reference points. Reference points generally indicate areas based on which a suitable focusing is to be determined. The reference points in the coarse-focus strategy and the fine-focus strategy can differ; in particular, the coarse-focus strategy can use different reference points and reference points that are further apart than in the fine-focus strategy. It is also possible for the position and number of reference points to be selected differently as a function of the sample carrier type (for example, for slides with tissue sections or multiwell plates).

Parameters of the coarse-focus strategy and/or parameters of the fine-focus strategy can define when and with which focus method focus settings should be checked and, when necessary, corrected during an ongoing experiment. The parameters can also specify that, to check the focus, a focus determination according to the fine-focus strategy is performed first, and only if this fails is the coarse-focus strategy invoked for the focus determination.

The parameters can also define an action in the event of an error, for example when a focus cannot be found. The decision as to whether a focus (of a sufficient quality) can be found can be evaluated, for example, based on the focusing criteria already mentioned, such as image sharpness or variance.

The parameters of the coarse-focus strategy and of the fine-focus strategy can define an alteration of the coarse-focus strategy or fine-focus strategy in the event that a focus cannot be determined using the coarse-focus or fine-focus strategy, or in the event that a focus cannot be determined or can no longer be determined using an initially employed coarse-focus or fine-focus strategy. The alteration can in particular specify a modification of a focus search range, a step size, lateral reference points and/or of an autofocus method (for example, use of a hardware autofocus method instead of a software autofocus method).

The microscope settings derived using the database can thus define a focus strategy as described in the foregoing, which is used to conduct an experiment or capture at least one microscope image. The focus strategy can be defined by means of the database in addition or alternatively to the other described microscope settings. It is not necessary for values of the same microscope settings or of the same parameters of a focus strategy to be stored for every embedding stored in the database. For instance, for some embeddings, it is possible for only parameters of a focus strategy to be stored without microscope settings with which the desired imaging is to take place after a successful focusing, while for other embeddings no parameters of a focus strategy are stored, but rather, for example, the microscope settings with which a data capture is to be performed after a successful focusing. In these cases, the data or microscope settings stored for different embeddings can be used to define both the focus strategy and the subsequent data capture. Similarly, it is possible for the database to include two database parts, wherein one database part contains embeddings with associated parameters of the focus strategy and the other database part contains embeddings with other associated microscope settings. The embeddings of both database parts can be vectors in the same feature space or in different feature spaces. For each database part, the derivation of microscope settings and thus also of the focus strategy is carried out in the described manner.

### Sources of Experiment-Specific Contextual Information

An experiment description or experiment-specific contextual information input into the embedding model together with a textual experiment description can in principle stem from different sources, for example from a user, the microscope system, a workflow or a history of previous experiments.

A user input can in particular take the form of an active input of the information, for example in a text field, via voice input or via a software program (wizard). Additionally or alternatively, it is also possible for a user input to be provided in response to a specific query from a control software.

Experiment-specific contextual information that can be provided automatically by the microscope system is particularly well-suited to being automatically added to a textual experiment description and conjointly input into the embedding model. For instance, one or more of the following can be automatically entered into the embedding model as part of the experiment description:
provided equipment of an employed microscope system (for example available components and usage) as set boundary conditions;
a state and/or age of microscope components;
measures of a state or performance of microscope components;
log files with maintenance information on microscope components;
any available previous measurement results of an ongoing workflow, which can include, for example, a captured overview image, optionally with character recognition on the label areas; it is also possible for previous microscope settings of the same ongoing workflow to be taken into account, for example microscope settings for wells of a multiwell plate that have been analyzed thus far; and/or
a user-specific history of microscope settings used in past experiments. It is possible to use the history of the current user or the history for the current microscope system. Optionally, only a certain number of the most recent images are taken into account, for example the last three images of the same user. Alternatively or additionally, past microscope settings are given less weight as the past experiments increase in age.

### General Features

A microscope experiment can be understood as a measurement process using a microscope during which one or more measurements are performed. Measurements can first be performed within the framework of the experiment to define properties of the actual experiment, for example by identifying and localizing sample areas of interest.

Microscope settings can specify all values and settings that need to be set on the microscope or in the microscope control software in order to conduct a microscope experiment. This includes the values for capturing an image as well as, optionally, values for successive measurements within the framework of the experiment. It can also include values or settings for determining the values used in the actual experiment: for example, the microscope settings can specify how a focus position is determined that is then used to perform the microscope experiment. In order to determine the focus position, a z-focus step size and a z-focus search range covered by the z-focus steps, for example, can be defined for a coarse focusing, and a smaller z-focus step size with a new z-range around the z-focus value determined in the coarse focusing can be defined for a subsequent fine focusing. In the context of the present invention, microscope settings are also called microscope parameters or microscope imaging parameters.

The terms “embeddings” and “embedding vector” both refer to a point or vector (embedding vector) in the feature space and represent the mapping of an experiment description into the feature space calculated by the embedding model. For an easy linguistic differentiation, the feature space representation of an experiment description of a new experiment for which suitable microscope settings are being sought is referred to as an “embedding vector”, while the feature space representations stored in the database for experiment descriptions of previous experiments, for which suitable microscope settings are known and stored in the database, are referred to as “embeddings”.

A microscope image can be understood as an image that is captured by a microscope or that is calculated using measurement data of a microscope. The microscope image can in particular be formed by one or more raw images or further processed images of the microscope and can include 2D image data or a 3D image stack or volumetric data, or alternatively time-series data in which 2D or 3D image data of the same object was captured at different points in time.

In principle, microscope images can depict any structure or object. In addition to the sample itself, for example biological structures, electronic elements or rock fragments, it is also possible for a sample vessel, a sample carrier, or a microscope component such as a sample stage or areas of the same to be depicted.

The microscope can be a light microscope with a system camera and, optionally, a separate overview camera. The overview camera or its objective is optionally non-telecentric. Other types of microscopes are also possible, for example electron microscopes, X-ray microscopes or atomic force microscopes. A microscopy system refers to a device that includes at least one computing device and one microscope.

The computing device can be designed in a decentralized manner, can be physically part of the microscope, or can be arranged separately in the vicinity of the microscope or at a location at any distance from the microscope. It can generally be formed by any combination of electronics and software and can in particular include a computer, a server, a cloud-based computing system or one or more microprocessors or graphics processors. The computing device can also be configured to control microscope components.

In the context of the present invention, an annotation is understood to be a target result ideally calculated by a model in training from an input associated with the annotation. The deviation between the model output and the annotation is used in the training to adjust the model parameters/weights. Depending on the model, an annotation can be an image, can include image data or a segmentation mask, or can be formed by other data, for example numerical values or classifications by object type or size. In contrast to an annotation, a piece of contextual information refers to data that is input into the model as part of the input data for the calculation of the model output from the same.

Formulations such as “based on”, “using”, “depending on” or “as a function of” are not to be understood as exhaustive, so that further dependencies can exist. Descriptions in the singular are intended to cover the variants “exactly 1” as well as “at least one”. For example, one or more experiment descriptions can be received and used to calculate one or more embedding vectors by means of the embedding model. In one example, a plurality of experiment descriptions result from the user instruction: “Capture images as described in the three articles . . . ”. Based on this instruction, a plurality of embedding vectors can be calculated (for example, one embedding vector per article) or a single embedding vector can be calculated, for example, by merging the plurality of experiment descriptions and then inputting the merged experiment description into the embedding model, or by respectively calculating an embedding vector for the experiment description of each article and subsequently averaging the embedding vectors or the associated microscope settings for different embeddings.

The characteristics of the invention that have been described as additional apparatus features also yield, when implemented as intended, variants of the method according to the invention. Conversely, the microscopy system or in particular the computing device and/or the computer program can be configured to execute the described method variants. Described training processes of machine-learned networks, in particular of the embedding model, define features of the ready-trained network, wherein different method variants are defined so that either the described training processes constitute method steps of a method according to the invention that are to be carried out or, alternatively, an accordingly trained model is used in the inference phase.

### BRIEF DESCRIPTION OF THE FIGURES

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 is a schematic depiction of processes of an example embodiment of the invention;

FIG. 2 is a schematic depiction of processes of a further example embodiment of the invention;

FIG. 3 is a flowchart with processes of a further example embodiment of the invention; and

FIG. 4 schematically shows an example embodiment of a microscopy system according to the invention.

### DETAILED DESCRIPTION OF EXAMPLE EMBODIMENTS

Different example embodiments are described in the following with reference to the figures.

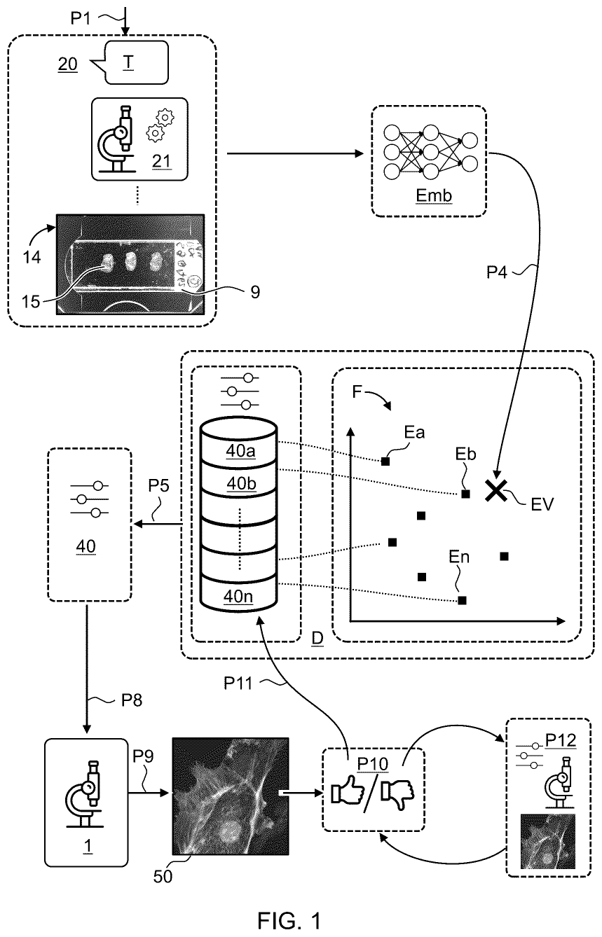

FIG. 1: Determining microscope settings based on an experiment description using an embedding vector and associated database

FIG. 1 schematically shows processes of an example embodiment of a computer-implemented method according to the invention for defining microscope settings for a planned microscope experiment.

First, in process P1, an experiment description 20 is received, which includes at least one textual description T relating to a planned sample analysis. The textual description T can be written by a user in natural language and input in text form or via voice input. An example of a textual description T of the experiment is: “HeLa cells are analyzed by fluorescence imaging with DAPI and Alexa 488 dyes; the focus is on image quality; a strong bleaching of the samples is permitted”. Alternatively, the textual description T can be, for example, a scientific article in which, among other things, imaging parameters of an experiment are described.

In addition to the textual description T, the experiment description 20 can also contain further experiment-specific contextual information. In the example shown, the experiment description 20 includes automatically ascertained microscopy system data 21, for example relating to the provided equipment of the employed microscopy system, a state of the available microscopy components and log files with maintenance information regarding the microscopy components. In this example, the experiment description 20 also includes image data, in particular a macroscopic overview image 14 in which a sample carrier 9 with a sample 15 is visible.

The experiment description 20 is input into an embedding model Emb, which calculates an embedding vector EV based on the experiment description 20 in process P4. The embedding vector EV represents a mapping or embedding of the experiment description 20 into a feature space F.

The embedding model Emb can be a machine-learned model, in particular an encoder. In principle, the encoder can have been learned in different ways, for example in a structure as an autoencoder and/or in a supervised training with largely arbitrary annotations, which are used, for example, for a classification with regard to microscope settings or other properties. The task in such a supervised training can differ from or be independent of the present task of finding microscope settings for a microscope experiment, since it is already sufficient that an encoder is learned that maps an experiment description to a semantic feature space in which points (vectors) that are close to each other describe similar experiments. Since the decoder or classifier is ignored after a training of an autoencoder or classification model and only the encoder is used as the embedding model Emb, the design and effect of the decoder or classifier are not essential.

Next, a database D is used in which a set of microscope settings 40a to 40n is respectively stored for different points in the feature space F (referred to as embeddings E1 to En here). The embeddings E1 to En were calculated at earlier points in time by the embedding model Emb from past experiment descriptions. Respectively suitable microscope settings already existed for these past experiment descriptions, namely microscope settings 40a to 40n. These can originate from experienced microscope users.

In process P5, microscope settings 40 are derived from the embedding vector EV using the database D. To this end, it can be determined, for example, which of the embeddings Ea to En stored in the database D is closest to the embedding vector EV in the feature space F in terms of distance. The terms “embeddings” and “embedding vector” are used here to make it easier to distinguish linguistically between an embedding of a new experiment description and the embeddings of previous experiment descriptions stored in the database, although both terms refer to a point/vector in the feature space F.

The microscope settings stored in the database D for the embedding that is closest to the embedding vector EV are used as microscope settings 40 in this variant embodiment. In the example shown, these are the microscope settings 40b for the embedding Eb.

The derived microscope settings 40 are used in process P8 to control a microscope 1 in order to conduct the microscope experiment and capture at least one microscope image 50 in process P9.

In process P10, an evaluation of the at least one microscope image 50 is carried out to assess whether the employed microscope settings 40 were apt or whether they should be improved. The evaluation of the microscope image 50 can be based on general image properties (for example image sharpness, image noise, image contrast) and/or involve experiment-specific criteria. The experiment-specific criteria can be derived automatically from the experiment description 20, for example by an LLM instructed to do so. For example, the experiment description 20 can include a sample type (HeLa cells) and characteristics relevant for its representation (employed dye, e.g. Alexa 488). Different machine-learned models can be stored that recognize certain structures (e.g. different sample types) in images in a specific representation (e.g. fluorescence measurement with a specific dye), for example by detection, classification or segmentation. The experiment-specific criteria now specify which of the machine-learned models should be selected or that the stored machine-learned models are used to calculate whether the desired sample type is actually visible in the captured microscope image 50.

In the event of a positive evaluation in process P10, the microscope settings 40 are classified as apt to conduct the microscope experiment successfully. This is followed in process P11 by the entry of the embedding vector EV and the associated microscope settings 40 in the database D. The database D is thus expanded by suitable data points that can be used for future experiments in the described manner.

An important advantage of the invention is that the continuous expansion of the database D is relatively easy. The determination of suitable microscope settings for new experiments thereby becomes increasingly accurate over time and can be adapted to new types of experiments. A new training of a machine-learned model is not necessary. This distinguishes the solution according to the invention from different approaches of the prior art. If a machine-learned model were used to map experiment descriptions to microscope settings, this model would have to undergo a follow-up training to take new pairs of experiment descriptions and associated microscope settings into account. This follow-up training can be omitted with the described database D. This advantage is particularly relevant with modern neural networks, as modern networks require a training that is increasingly onerous while detailed expertise is necessary to conduct a high-quality training.

If process P10 results in an evaluation that at least one microscope image 50 is of insufficient quality, a refining of the microscope settings 40 follows in process P12. The refinement can be carried out by a user or by means of software, for example an adaptive algorithm learned through reinforcement learning. It is also possible to generate different sets of microscope settings for the refinement and to capture a test image for each set, wherein it is subsequently evaluated which test image offers the best quality (for example, as described in process P10), and the experiment is then conducted with the microscope settings of the test image with the best evaluation. An evaluation is then carried out again in process P10, and if the evaluation result is positive, the refined microscope settings are entered in the database D.

If microscope settings 40 or refined microscope settings are evaluated as unsuitable in process P10, it is optionally possible for a corresponding entry to be made in the database. This negative entry is used to prevent these microscope settings from being used for the corresponding point in the feature space F. For a possible implementation, the closest (for example, the five closest) embeddings in the feature space F can be determined for an embedding vector, wherein microscope settings (that have been evaluated as correct) are respectively stored in the database for the determined embeddings. The microscope settings of these closest embeddings are combined; for example, a mean value weighted according to proximity is calculated from the values for each of the microscope settings. If an embedding stored as unsuitable is among the closest embeddings, it is possible to increase a distance between the mean value (calculated from the values of correct microscope settings) and the corresponding microscope setting of the negative entry. In a simple numerical example without a weighting by proximity/distance in the feature space, the values of a microscope setting of five selected embeddings are 15, 17, 18, 19, 21, which gives an arithmetic mean of 18. An embedding that specifies the value 21 for this microscope setting was saved as a negative entry. The mean value 18 is now modified so as to increase its distance from the value 21, i.e. the mean value in this numerical example is reduced, for example by the difference between the mean value and the value of the negative entry divided by the number of embeddings considered, i.e. six embeddings in this numerical example, so that the mean value is reduced by (21-18)/6 to 17.5.

The fact that embeddings of experiment descriptions, as opposed to the experiment descriptions themselves, are stored in the database D offers additional advantages for an expansion of the database D, since the embedding can provide an additional degree of data anonymization, which facilitates the addition of new data points.

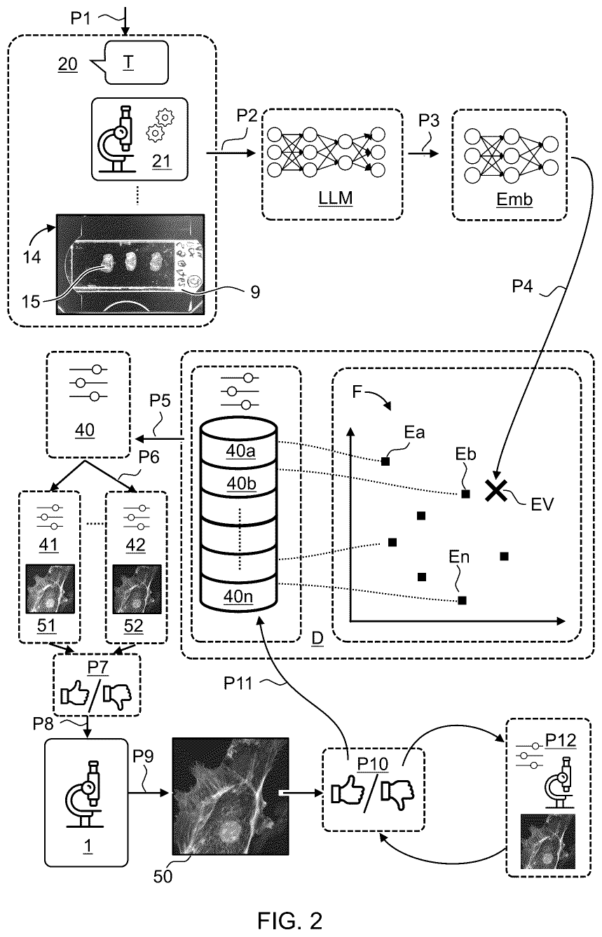

### FIG. 2: Extension of the Example of FIG. 1

The example embodiment of FIG. 1 can be supplemented by further processes, as shown by way of example in FIG. 2.

In this case, the experiment description 20 is first input into a machine-learned language model (large language model) LLM in process P2. This model is trained or instructed to standardize the experiment description 20 in process P3. This standardization renders the representation or presentation of experiment descriptions uniform. In particular, the experiment description 20 is standardized according to a predetermined language and/or a predetermined (neutral) text style. Personal data, for example patient names, can also be removed or anonymized. Standardization facilitates a comparison of experiment descriptions and allows aspects to be removed that are irrelevant for the determination of suitable microscope settings.

After the standardization, the experiment description 20 is input into the embedding model Emb, which calculates the embedding vector EV from the experiment description 20 in process P4, as already described in relation to the preceding figure.

Standardization increases a confidence that a proximity in the feature space F of the embedding model Emb actually represents similar experiments for which similar microscope settings are suitable. Forms of presentation or a writing style of the textual experiment description, on the other hand, thereby do not affect the distance separating the embeddings of different experiment descriptions in the feature space.

Experiment descriptions of past microscope experiments for which an embedding with associated microscope settings is stored in the database D were pre-processed in the same manner as described above for the experiment description of a new microscope experiment, i.e. the LLM was used in the described manner.

The example shown in FIG. 2 additionally involves a refinement of microscope settings 40 derived in process P5 using the database D and the embedding vector EV. FIG. 2 shows that after process P5, in process P6, a plurality of variations of microscope settings 41-42 are formed. To this end, the values of the derived microscope settings 40 are varied (slightly), for example randomly. At least one test image 51-52 is respectively captured with the microscope using the derived microscope settings 40 and each set of varied microscope settings 41-42. The test images are subsequently evaluated in process P7 (for example according to image quality, in particular sharpness, contrast or noise) and the (varied) microscope settings of the test image with the best evaluation are then used in process P8, as already described in relation to the preceding figure.

In the event of an expansion of the database in process P11, the employed microscope settings (which, where necessary, were refined in process P6) are entered in the database.

The test images 51, 52 for varied microscope settings 41, 42 can differ in quality from the at least one microscope image 50 captured in the microscope experiment. For example, the test images 51, 52 can respectively include a single microscope image. In contrast, numerous microscope images can be captured for a microscope experiment, for example a plurality of laterally offset image patches that are assembled into a panoramic image, images of different height planes, and/or a plurality of images of the same sample section at different points in time for a long-term analysis. The test images 51, 52 thus provide a quick way to check and optimize microscope settings before a much more time-consuming microscope experiment is carried out. For the test images 51, 52, not all the determined microscope settings are necessarily taken into account; for example, the z-step size at which different height planes are analyzed or the size of a lateral overlap of image patches for an image stitching may be disregarded.

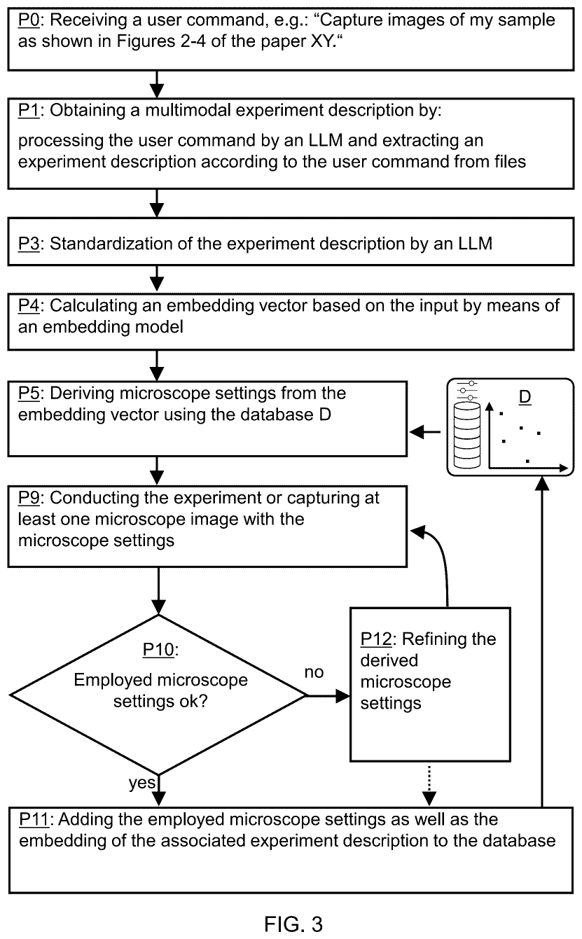

### FIG. 3: Flowchart of a Method According to the Invention

Processes of a further example embodiment of a method according to the invention are shown as a flowchart in FIG. 3.

In this example, a user command is first received in process P0, for example a voice input: “Capture images of my sample as shown in FIGS. 2-4 of the paper . . . ” The subsequent receipt of an experiment description in process P1 includes an evaluation of the user command by a large language model, to which end an article named by the user is identified and loaded, and an experiment description is extracted from the article together with associated images.

The thus received experiment description is subsequently standardized in process P3 and used in further processes as described in relation to the preceding figures.

As an optional variation of or addition to the processes of the preceding figures, the evaluation of whether microscope settings used in the microscope experiment were suitable can also be carried out independently of a captured image in process P10. For instance, the experiment is evaluated as unsuccessful if an experiment duration is longer than the time for which an immersion on a sample carrier can be maintained with a given tank size of an immersion unit. The microscope settings can also be evaluated as unsuitable in the event of a collision between a sample carrier and an objective or some other microscope component. For example, a breaking of a cover glass due to a collision can be detected acoustically via a microphone on the microscope, i.e. without an image evaluation, in order to establish that the experiment has failed.

If microscope settings are classified as unsuitable in process P10 and subsequently refined in process P12, either a new experiment/imaging can be carried out in process P9 with a subsequent evaluation of the refined microscope settings in process P10, or alternatively, the microscope settings refined in process P12 can be entered directly into the database (dotted line in FIG. 3 to process P11) without repeating the experiment. For example, if it was first determined in process P10 that captured images of a plurality of height planes were suitable, but the images of an outermost height plane were outside the sample area, the refined microscope settings can be defined so that only certain images (in this case, of the outermost height plane) are discarded—in this case, it is not necessary to repeat the experiment, and the thus refined microscope settings can be entered directly in the database.

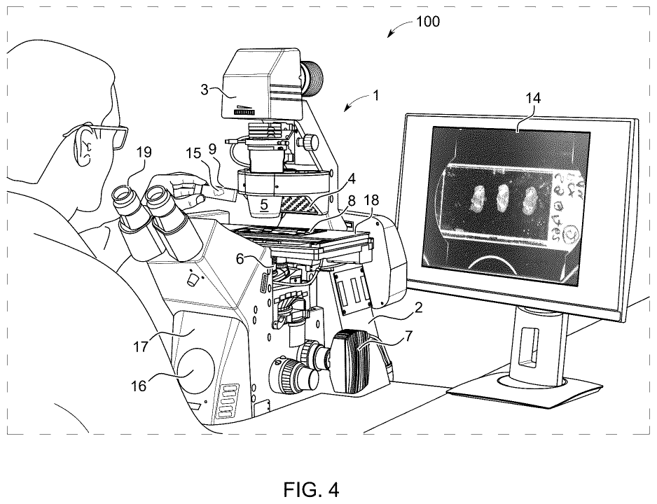

### FIG. 4: Microscope

FIG. 4 shows an example embodiment of a microscope system 100 according to the invention. The microscope system 100 includes a microscope 1 and a computing device 17, which can be part of the microscope 1 or separate from the microscope 1. The microscope 1 includes a stand 2 via which further microscope components are supported. The latter can in particular include: an illumination device 3; a condenser 5 for guiding illumination light to a sample area; an objective changer or revolver, on which an objective 6 is mounted in the illustrated example; a sample stage 18 with a holding frame 8 for holding a sample carrier 9; and a microscope camera 7. When the objective 6 is pivoted into the light path of the microscope, the microscope camera 7 receives detection light from a sample area in which a sample 15 can be located in order to capture a microscope image. In principle, a sample 15 can be or can include any object, fluid or structure. To capture a microscope image that can serve as an overview image 14 of a sample environment, the microscope 1 can use an objective with a lower magnification and/or an optional additional overview camera (not illustrated), which views the sample area from a perpendicular or oblique angle. For the capture of an overview image, an illumination can be used that includes, for example, a plurality of LEDs 4 whose illumination direction for a dark-field measurement is oriented obliquely to a detection axis. In addition to the microscope camera 7, a sample can also be observed through an eyepiece 19. The microscopy system 100 also includes a computer program 16, depicted only schematically, which is stored on a non-volatile data memory. The computer program 16 or the computing device 17 is configured to execute the method variants described in connection with the other figures. In the illustrated example, the microscope 1 is a light microscope, but in principle it can also be another type of microscope.

The variants described in relation to the different figures can be combined with one another. The described example embodiments are purely illustrative and variants of the same are possible within the scope of the attached claims.

### LIST OF REFERENCE SIGNS

1 Microscope
2 Stand
3 Illumination device
4 LEDs
5 Condenser
6 Objective
7 Microscope camera/system camera
8 Support frame for holding a sample carrier
9 Sample carrier
14 Microscope image/overview image
15 Sample
16 Computer program
17 Computing device
18 Sample stage
19 Eyepiece
20 Experiment description
21 Microscopy system data
40 Derived microscope settings
40a-40n Microscope settings stored in the database D
41-42 Varied microscope settings for test images
50 Microscope image
51 Test images with varied microscope settings
100 Microscopy system
D Database with embeddings Ea-En for experiment descriptions and respectively associated predetermined microscope settings 40a-40n
Ea-En Embeddings stored in the database D
Emb Embedding model
EV Embedding vector of the experiment description
F Feature space
LLM Language model/large language model
P0-P12 Processes of methods according to the invention
T Textual description as part of the experiment description

What is claimed is:

1. A computer-implemented method for defining microscope settings for a planned microscope experiment, wherein the method includes at least:
receiving an experiment description that includes at least one textual description pertaining to a planned sample analysis;
calculating an embedding vector based on the experiment description using an embedding model;
deriving microscope settings from the embedding vector using a database that contains stored embeddings for experiment descriptions with respectively associated predetermined microscope settings; and
using the derived microscope settings to capture at least one microscope image.

2. The method according to claim 1, further including:
inputting the experiment description into a machine-learned language model which standardizes the experiment description at least with regard to a language, a writing style and a data format, and
inputting the experiment description into the embedding model only after standardization.

3. The method according to claim 1, wherein the experiment description is input into the embedding model as part of multimodal experiment-specific contextual information that includes at least text data and image data, wherein the image data includes a macroscopic overview image of an employed sample carrier with a sample.

4. The method according to claim 1, wherein the deriving of microscope settings from the embedding vector using the database includes at least the following:
determining which of the stored embeddings of the database is closest to the embedding vector in a feature space of the embedding model in terms of distance and defining the microscope settings at least based on the microscope settings of the closest stored embedding.

5. The method according to claim 1, which further includes:
selecting a plurality of the stored embeddings according to their proximity to the embedding vector in a feature space of the embedding model;
wherein the deriving of the microscope settings is based on the microscope settings of the selected plurality of stored embeddings;
wherein:
a number of embeddings to be selected is predetermined; or
every stored embedding within a predefined radius around the embedding vector is selected; or
a further closest embedding is selected repeatedly until a ratio of a distance between a last selected embedding and a further embedding exceeds a predetermined threshold value.

6. The method according to claim 1, wherein the deriving of microscope settings from the embedding vector using the database includes at least:
clustering the embeddings in a feature space of the embedding model and determining a cluster associated with the embedding vector; and
deriving microscope settings from the microscope settings of the embeddings of the associated cluster.

7. The method according to claim 5, wherein, for microscope settings with a continuous value range, the microscope settings of a plurality of selected embeddings are combined with one another by weighted averaging.

8. The method according to claim 1, which further includes:
asking a user or a control software: A) to approve the derived microscope settings in order to capture at least one microscope image using the derived microscope settings, or B) to refine the derived microscope settings in order to obtain refined microscope settings for the planned microscope experiment.

9. The method according to claim 1, which further includes:
fine-tuning the derived microscope settings by:
capturing a plurality of test images with differently varied microscope settings;
evaluating the test images; and
using microscope settings for a test image with a best evaluation for the planned microscope experiment.

10. The method according to claim 1, which further includes:
fine-tuning the derived microscope settings using an adaptive algorithm, wherein the adaptive algorithm was learned by machine learning using results for test images with differently varied microscope settings.

11. The method according to claim 1, which further includes:
expanding the database by the embedding vector of the experiment description and the associated derived microscope settings, provided that the derived microscope settings have been approved.

12. The method according to claim 1, which further includes:
provided that a refining of the derived microscope settings has been carried out, expanding the database by the embedding vector of the experiment description and the associated refined microscope settings.

13. The method according to claim 1, which further includes:
expanding the database by the embedding vector of the experiment description and the associated derived microscope settings after completion of the microscope experiment, provided that there occurred neither an aborting of a measurement or a discarding of captured microscope images by a user or a control software.

14. The method according to claim 1,
wherein, in the case of an expansion of the database by an embedding vector and associated microscope settings, the following is provided for a data augmentation:
anonymizing, standardizing and forming a plurality of variations of the experiment description;
calculating embeddings of the variations of the experiment description using the embedding model; and
expanding the database by the embeddings of the variations of the experiment description together with the microscope settings associated with the embedding vector.

15. The method according to claim 1, which further includes:
deriving a plurality of sets of microscope settings from the embedding vector using the database;
wherein the sets of microscope settings differ in at least one microscope setting with discrete value options;
offering the plurality of sets of microscope settings to a user or a control software for selection of one of the sets of microscope settings in order to carry out the microscope experiment or capture at least one microscope image and to expand the database.

16. The method according to claim 1,
wherein one or more of the following is automatically additionally entered into the embedding model as part of the experiment description:
information on provided equipment of an employed microscopy system as fixed boundary conditions;
information on a state or age of microscope components;
measures of a state or performance of microscope components;
log files with maintenance information on microscope components;
a user-specific history of microscope settings used in past experiments; and
any available previous measurement results of an ongoing workflow.

17. The method according to claim 1,
wherein the embedding model is or includes a machine-learned deep neural network, and
wherein contents of the database are stored in the form of tabular values and not as model parameter values of a machine-learned model.

18. The method according to claim 1,
wherein at least some of the predetermined microscope settings stored in the database for the stored embeddings define parameters of a focus strategy, wherein the derivation of microscope settings from the embedding vector using the database includes a deriving of a focus strategy, and
wherein the derived focus strategy is used to conduct the planned microscope experiment.

19. The method according to claim 18,
wherein the focus strategy includes a coarse-focus strategy and a fine-focus strategy,
wherein the parameters specify an autofocus method to be used for the coarse-focus strategy and the fine-focus strategy, respectively,
wherein the parameters for the coarse-focus strategy and the fine-focus strategy respectively specify a number and a lateral position of autofocus reference points; and
wherein the parameters define when and with which autofocus method focus settings are to be checked during an ongoing experiment.

20. A microscopy system including:
a microscope for image capture; and
a computing device configured to execute the computer-implemented method of claim 1.

21. A non-volatile computer-readable data storage device containing a computer program that includes instructions which, when executed by a computer, cause the computer to execute the method according to claim 1.
